(19) United States
(12) Patent Application Publication
(10) Pub. No.: US 2024/0152386 A1
(43) Pub. Date: May 9, 2024

(54) ARTIFICIAL INTELLIGENCE ACCELERATOR AND OPERATING METHOD THEREOF

(71) Applicant: INDUSTRIAL TECHNOLOGY RESEARCH INSTITUTE, Hsinchu (TW)

(72) Inventors: Yao-Hua CHEN, Changhua County (TW); Juin-Ming LU, Hsinchu City (TW)

(73) Assignee: INDUSTRIAL TECHNOLOGY RESEARCH INSTITUTE, Hsinchu (TW)

(21) Appl. No.: 18/383,819

(22) Filed: Oct. 25, 2023

(30) Foreign Application Priority Data
Nov. 9, 2022 (TW) 111142811

(51) Int. Cl. G06F 9/48

(52) U.S. Cl. CPC G06F 9/4843

(57) ABSTRACT

An artificial intelligence accelerator includes an external command dispatcher, a first data access unit, a second data access unit, a global buffer, an internal command dispatcher, and a data/command switch. The external command dispatcher receives an address and access information. The external command dispatcher sends the access information to one of the first data access unit and the second data access unit, the first data access unit receives first data from a storage device according to the access information, and sends the first data to the global buffer. The second data access unit receives second data from the storage device according to the access information, and sends the second data. The data/command switch receives the address and the second data from the second data access unit, and sends the second data to one of the global buffer and the internal command dispatcher.

### CROSS-REFERENCE TO RELATED APPLICATIONS

This non-provisional application claims priority under 35 U.S.C. § 119(a) on Patent Application No(s). 111142811 filed in Taiwan, R.O.C. on Nov. 9, 2022, the entire contents of which are hereby incorporated by reference.

### TECHNICAL FIELD

The present disclosure relates to the artificial intelligence accelerator and its operating method.

### BACKGROUND

In recent years, with the vigorous development of artificial intelligence (AI) related applications, the complexity and computing time of AI algorithms continue to rise, and the demand for the AI accelerator has also increased at the same time.

Currently, the design of the AI accelerator mainly focuses on how to improve the computing speed and adapt to new algorithms. However, from the perspective of system application, in addition to the computing speed of the accelerator itself, the data transmission speed is also a key factor that affects the overall performance.

In general, the computing speed and data transmission speed may be improved by increasing the number of processing units and the transmission channels of the storage device. However, the control commands of the AI accelerator become more complex due to the newly added computing units and transmission channels. Moreover, the transmission of control commands takes a lot of time and occupies a large amount of bandwidth.

In addition, existing technologies such as Near-Memory Processing (NMP), Function-In Memory (FIM), and Processing-in-Memory (PIM) still use the traditional RISC instruction set to implement control commands. However, it has to send a plurality of commands to control a plurality of control registers in a plurality of sequencers, and this increases the overhead of command transmission.

### SUMMARY

According to an embodiment of the present disclosure, an artificial intelligence accelerator includes an external command dispatcher, a first data access unit, a second data access unit, and a data/command switch. The external command dispatcher is configured to receive an address and access information. The first data access unit is electrically connected to the external command dispatcher and a global buffer. The first data access unit is configured to obtain first data from a storage device according to the access information, and send the first data to the global buffer. The second data access unit is electrically connected to the external command dispatcher, wherein the second data access unit is configured to obtain second data from the storage device according to the access information, and send the second data. The external command dispatcher sends the access information to one of the first data access unit and the second data access unit according to the address. The data/command switch is electrically connected the second data access unit, the global buffer and an internal command dispatcher. The data/command switch is configured to obtain the address and the second data from the second data access unit, and send the second data to one of the global buffer and the internal command dispatcher according to the address.

According to an embodiment of the present disclosure, an operating method of an artificial intelligence accelerator includes a plurality of steps. The artificial intelligence accelerator includes an external command dispatcher, a global buffer, a first data access unit, a second data access unit, an internal command dispatcher and a data/command switch. The plurality of steps includes: receiving, by the external command dispatcher, an address and access information; sending, by the external command dispatcher, the access information to one of the first data access unit and the second data access unit according to the address; when the access information is sent to the first data access unit: obtaining, by the first data access unit, first data from a storage device according to the access information; and sending, by the first data access unit, the first data to the global buffer; and when the access information is sent to the second data access unit: obtaining, by the second data access unit, second data from the storage device according to the access information and sending the second data and the address to the data/command switch; and sending, by the data/command switch, the second data to one of the global buffer and the internal command dispatcher according to the address.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of an artificial intelligence accelerator according to an embodiment of the present disclosure;

FIG. 2 is a flowchart of an operating method of the artificial intelligence accelerator according to an embodiment of the present disclosure; and

FIG. 3 is a flowchart of the operating method of the artificial intelligence accelerator according to another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

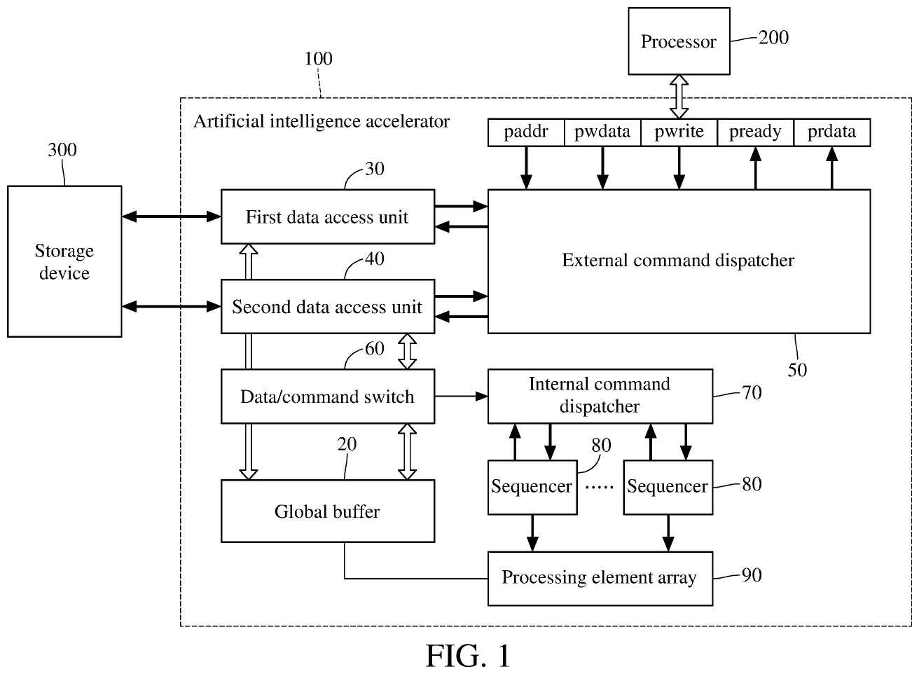

FIG. 1 is a block diagram of an artificial intelligence accelerator according to an embodiment of the present disclosure. As shown in FIG. 1, the artificial intelligence accelerator 100 is electrically connected to a processor 200 and a storage device 300. For example, the processor 200 adopts the RISC-V instruction set architecture, and the storage device 300 is implemented by Dynamic Random Access Memory Cluster (DRAM Cluster). However, the present disclosure does not limit the hardware types of the processor 200 and the storage device 300 suitable for the artificial intelligence accelerator 100.

As shown in FIG. 1, the artificial intelligence accelerator 100 includes a global buffer 20, a first data access unit 30, a second data access unit 40, an external command dispatcher 50, a data/command switch 60, an internal command dispatcher 70, a sequencer 80, and a processing element array 90.

The global buffer 20 is electrically connected to the processing element array 90. The global buffer 20 includes a plurality of memory banks and a controller that controls data access with the memory banks. Each memory bank corresponds to the data required for the operations of the processing element array 90, such as the filter, the input feature map, and the partial sum during the convolution operation. Each memory bank may be divided into smaller memory banks according to the requirements. In an embodiment, the global buffer 20 is implemented by the Static Random Access Memory (SRAM).

The first data access unit 30 is electrically connected to the global buffer 20 and the external command dispatcher 50. The first data access unit 30 is configured to obtain first data from the storage device 300 according to the access information sent from the external command dispatcher 50, and send the first data to the global buffer 20. The second data access unit 40 is electrically connected to the external command dispatcher 50 and the data/command switch 60. The second data access unit 40 is configured to obtain second data from the storage device 300 according to the access information.

The first data access unit 30 and the second data access unit 40 are configured to perform data transmissions between the storage device 300 and the artificial intelligence accelerator 100. The difference is that the data transmitted by the first data access unit 30 is of “data” type, while the data transmitted by the second data access unit 40 may be the “data” type or the “command” type. The data required for the operation of the processing element array 90 belongs to the “data” type, while the data used to control the processing element array 90 to perform calculations with a specified processing unit at a specified time belongs to the “command” type. In an embodiment, the first data access unit 30 and the second data access unit 40 are communicably connected to the storage device 300 through a bus.

The present disclosure does not limit the respective quantities of the first data access unit 30 and the second data access unit 40. In an embodiment, the first data access unit 30 and the second data access unit 40 may be implemented by using Direct Memory Access (DMA) technology.

The external command dispatcher 50 is electrically connected to the first data access unit 30 and the second data access unit 40. The external command dispatcher 50 receives an address and the access information from the processor 200. In an embodiment, the external command dispatcher 50 is communicably connected to processor 200 the through a bus. The external command dispatcher 50 sends the access information to one of the first data access unit 30 and the second data access unit 40 according to the address. Specifically, the aforementioned address indicates the address of the data access unit to be activated; in this embodiment, it is the address of the first data access unit 30 or the address of the second data access unit 40. The access information includes the address of the storage device 300. In the example shown in FIG. 1, the address and the access information conform to APB bus format, and this format includes an address (paddr), access information (pwdata), a write enable signal (pwrite), a read enable signal (prdata) and a read data (prdata).

The following example illustrates the operation of the external command dispatcher 50, but the values in this example are not intended to limit the present disclosure. In an embodiment, if paddr[31:16]=0xd0d0, pwdata will be sent to the data access circuit. If paddr[31:16]=0xd0d1, pwdata will be sent to other hardware device(s). The data access circuit is the circuit integrating the first data access unit 30 and the second data access unit 40. If paddr[15:12]=0x0, pwdata will be sent to the first data access unit 30. If paddr[15:12]=0x1, pwdata will be sent to the second data access unit 40.

The data/command switch 60 is electrically connected to the global buffer 20, the second data access unit 40 and the internal command dispatcher 70. The data/command switch 60 obtains the address and the second data from the second data access unit 40, and sends the second data to one of the global buffer 20 and the internal command dispatcher 70 according to the address. Since the second data received from the storage device 300 by the second data access unit 40 may be of the data type or the command type, the present disclosure uses the data/command switch 60 to send the second data of different types to different places.

The following example illustrates the operation of the data/command switch 60, but the values in this example are not intended to limit the present disclosure. In an embodiment, if paddr[31:16]=0xd0d0, the second data will be loaded to the global buffer 20. If paddr[31:16]=0xd0d1, the second data will be loaded to the internal command dispatcher 70.

The internal command dispatcher 70 is electrically connected to a plurality of sequencers 80. The internal command dispatcher 70 may be viewed as the command dispatcher of sequencer of the sequencer 80. Each sequencer 80 includes a plurality of control registers. Filling specified values in these control registers may drive the processing element array 90 to perform specified operations. The processing element array 90 includes a plurality of processing elements. Each processing element is, for example, a multiplier-accumulator, which is responsible for the detailed operations of the convolution operation.

Overall, the processor 200 sends the control-related information, such as the address (paddr), the access information (pwdata), the write enable signal (pwrite), the read enable signal (prdata) and the read data (prdata), to the external command dispatcher 50 through the bus, thereby controlling the first data access unit 30 and the second data access unit 40. The values of the address (paddr) are used to control the processor 200 to send related information to one of the first data access unit 30 and the second data access unit 40. In addition, the function of the first data access unit 30 is to move data between the storage device 300 and the global buffer 20. As to the operation of the second data access unit 40, if paddr[31:16]=0xd0d0, the second data access unit 40 moves the second data between the storage device 300 and the global buffer 20. If paddr[31:16]=0xd0d1, the second data access unit 40 reads the second data from the storage device 300 and sends it to the internal command dispatcher 70, and writes to the sequencer 80 through the internal command dispatcher 70.

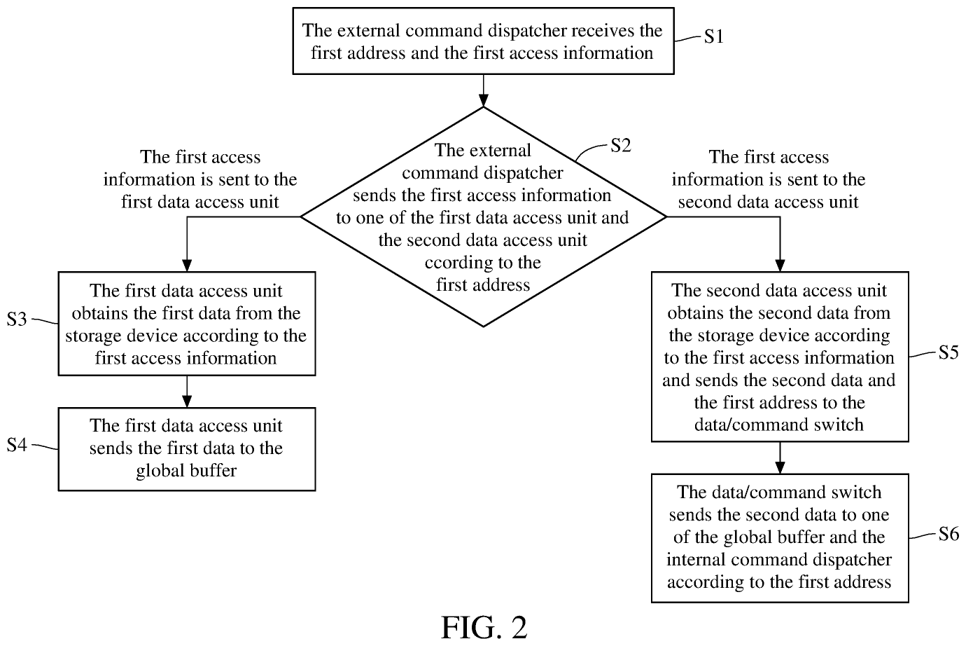

Please refer to FIG. 1 and FIG. 2. FIG. 2 is a flowchart of an operating method of the artificial intelligence accelerator according to an embodiment of the present disclosure. The method is applicable to the aforementioned artificial intelligence accelerator 100, and the method shown in FIG. 2 is that the artificial intelligence accelerator 100 obtains the required data from the external storage device 300.

In step S1, the external command dispatcher 50 receives the first address and the first access information. In an embodiment, the external command dispatcher 50 receives the first address and the first access information from the processor 200 electrically connected to the artificial intelligence accelerator 100. In an embodiment, the first address and the first access information conform to the bus format.

In step S2, the external command dispatcher 50 sends the first access information to one of the first data access unit 30 and the second data access unit 40 according to the first address. In an embodiment, the first address includes a plurality of bits, and the external command dispatcher 50 determines where to send the first access information according to one or more values of the plurality of bits. If the first access information is sent to the first data access unit 30, step S3 will be performed next. If the first access information is sent to the second data access unit 40, step S5 will be performed next.

In step S3, the first data access unit obtains the first data from the storage device 300 according to the first access information. In an embodiment, the first data access unit 30 is communicably connected to the storage device 300 through the bus. In an embodiment, the first access information indicates the specified reading position of the storage device 300.

In step S4, the first data access unit 30 sends the first data to the global buffer 20. In an embodiment, the first data is the input data required by the artificial intelligence accelerator 100 performing the convolution operation. The global buffer 20 has a controller, which is configured to send the first data to the processing element array for convolution operation at the specific timing.

In step S5, the second data access unit 40 obtains the second data from the storage device 300 according to the first access information and sends the second data and the first address to the data/command switch 60. The operation of the second data access unit 40 is similar to the operation of the first data access unit 30. The difference is that the second data obtained from the storage device 300 by the second data access unit 40 is of the data type or the command type, while the first data by the first data access unit 30 is of data type only. In an embodiment, the first access information indicates the specified reading position of the storage device 300.

In step S6, the data/command switch 60 sends the second data to one of the global buffer 20 and the internal command dispatcher 70 according to the first address. In an embodiment, the first address includes a plurality of bits, and the data/command switch 60 determines where to send the second data according to one or more values of the plurality of bits. The second data of data type will be sent to the global buffer 20, the second data of the command type will be sent to the internal command dispatcher 70.

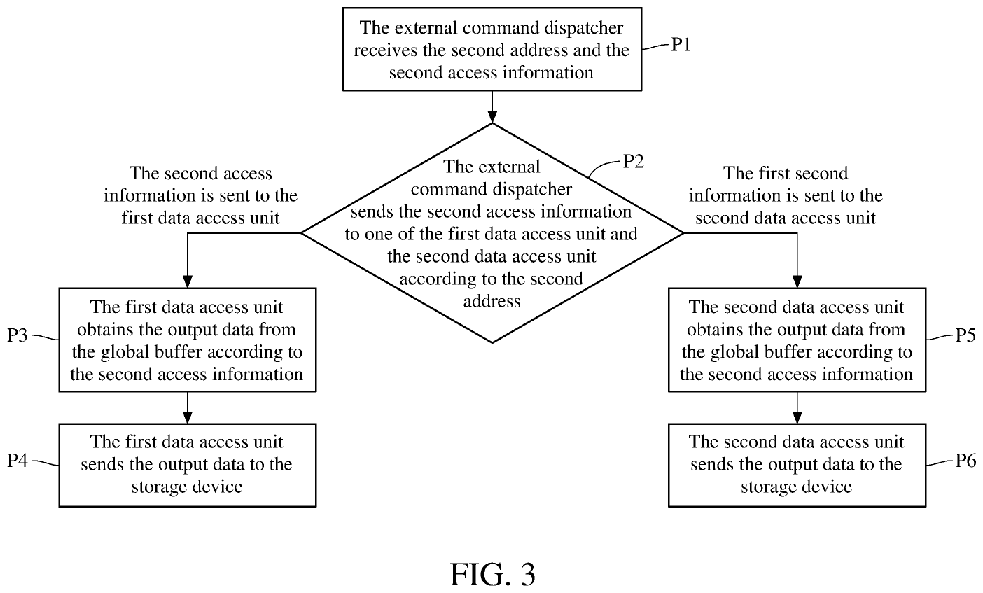

Please refer to FIG. 1 and FIG. 3. FIG. 3 is a flowchart of the operating method of the artificial intelligence accelerator according to another embodiment of the present disclosure. The method is applicable to the aforementioned artificial intelligence accelerator 100. Furthermore, the process shown in FIG. 2 is to write the data into the artificial intelligence accelerator 100, the process shown in FIG. 3 shows that the data is outputted to the external storage device 300 after one or more computations are completed by the artificial intelligence accelerator 100. The operating method of the artificial intelligence accelerator 100 may include processes shown in FIG. 2 and FIG. 3.

In step P1, the external command dispatcher 50 receives the second address and the second access information. In an embodiment, the external command dispatcher 50 receives the second address and the second access information from the processor 200 electrically connected to the artificial intelligence accelerator 100. In an embodiment, the second address and the second access information conform to a bus format.

In step P2, the external command dispatcher 50 sends the second access information to one of the first data access unit 30 and the second data access unit 40 according to the second address. In an embodiment, the second address includes a plurality of bits, and the external command dispatcher 50 determines where to send the second access information according to one or more value of these bits. If the second access information is sent to the first data access unit 30, step P3 will be performed. If the second access information is sent to the second data access unit 40, step P5 will be performed.

In step P3, the first data access unit 30 obtains the output data from the global buffer 20 according to the second access information. In an embodiment, the second access information indicates the specified reading position of the global buffer 20.

In step P4, the first data access unit 30 sends the output data to the storage device 300. In an embodiment, the first data access unit 30 is communicably connected to the storage device 300 through the bus. In an embodiment, the second access information indicates the specified writing position of the storage device 300.

In step P5, the second data access unit 40 obtains the output data from the global buffer 20 according to the second access information. In an embodiment, the second access information indicates the specified reading position of the global buffer 20.

In step P6, the second data access unit 40 sends the output data to the storage device 300.

In view of the above, the present disclosure proposes an artificial intelligence accelerator and its operating method, with a design for obtaining data or command through data access units, which may effectively reduce the overhead of instruction transmissions of the artificial intelligence accelerator, thereby improving the performance of the artificial intelligence accelerator.

In a practical testing, the artificial intelligence accelerator and its operating method with encapsulated instructions proposed by the present disclosure may reduce the command transmission time in the convolution operation to more than 38% of the overall processing time. In face recognition using ResNet-34-Half, compared with the artificial intelligence accelerator that does not use encapsulated instructions, the artificial intelligence accelerator with encapsulated instructions proposed by the present disclosure improves the processing speed from 7.97 to 12.42 (frames per second).

What is claimed is:

1. An artificial intelligence accelerator comprising:
an external command dispatcher configured to receive an address and access information;
a first data access unit electrically connected to the external command dispatcher and a global buffer, wherein the first data access unit is configured to obtain first data from a storage device according to the access information, and send the first data to the global buffer;
a second data access unit electrically connected to the external command dispatcher, wherein the second data access unit is configured to obtain second data from the storage device according to the access information, and send the second data;
wherein, the external command dispatcher sends the access information to one of the first data access unit and the second data access unit according to the address; and
a data/command switch electrically connected the second data access unit, the global buffer and an internal command dispatcher, wherein the data/command switch is configured to obtain the address and the second data from the second data access unit, and send the second data to one of the global buffer and the internal command dispatcher according to the address.

2. The artificial intelligence accelerator of claim 1, wherein the address and the access information conform to a bus format.

3. The artificial intelligence accelerator of claim 1, wherein:
the address is a first address, and the access information is first access information;
the external command dispatcher is further configured to receive a second address and second access information, and send the second access information to one of the first data access unit and the second data access unit according to the second address;
the first data access unit is further configured to obtain an output data from the global buffer according to the second access information; and
the second data access unit is further configured to obtain the second data from the global buffer according to the second access information, and send the second data.

4. An operating method of an artificial intelligence accelerator, wherein the artificial intelligence accelerator comprises an external command dispatcher, a global buffer, a first data access unit, a second data access unit, an internal command dispatcher and a data/command switch, and the operating method of the artificial intelligence accelerator comprises:
receiving, by the external command dispatcher, an address and access information;
sending, by the external command dispatcher, the access information to one of the first data access unit and the second data access unit according to the address;
when the access information is sent to the first data access unit:
obtaining, by the first data access unit, first data from a storage device according to the access information; and
sending, by the first data access unit, the first data to the global buffer; and
when the access information is sent to the second data access unit:
obtaining, by the second data access unit, second data from the storage device according to the access information and sending, by the second data access unit, the second data and the address to the data/command switch; and
sending, by the data/command switch, the second data to one of the global buffer and the internal command dispatcher according to the address.

5. The operating method of the artificial intelligence accelerator of claim 4, wherein the address and the access information conform to a bus format.

6. The operating method of the artificial intelligence accelerator of claim 4, wherein the address is a first address, the access information is first access information, and the operating method further comprises:
receiving, by the external command dispatcher, a second address and second access information;
sending, by the external command dispatcher, the second access information to one of the first data access unit and the second data access unit according to the second address;
when the second access information is sent to the first data access unit, obtaining, by the first data access unit, an output data from the global buffer according to the second access information;
when the second access information is sent to the second data access unit, obtaining, by the second data access unit, the output data from the global buffer according to the second access information; and
sending, by one of the first data access unit and the second data access unit, the output data to the storage device.

7. The operating method of the artificial intelligence accelerator of claim 6, wherein the second address and the second access information conform to a bus format.
